(19) United States
(12) Patent Application Publication
(10) Pub. No.: US 2021/0081234 A1
(43) Pub. Date: Mar. 18, 2021

(54) System and Method for Handling High Priority Management Interrupts

(71) Applicant: DELL PRODUCTS, LP, Round Rock, TX (US)

(72) Inventors: Wei Liu, Austin, TX (US); Quy Ngoc Hoang, Round Rock, TX (US); Wade Andrew Butcher, Cedar Park, TX (US); Mark W. Shutt, Austin, TX (US)

(21) Appl. No.: 16/575,286

(22) Filed: Sep. 18, 2019

(51) Int. Cl. G06F 9/48; G06F 11/30; G06F 9/54; G06F 9/52

(52) U.S. Cl. CPC G06F 9/4818; G06F 11/3024; G06F 2209/481; G06F 9/542; G06F 9/52; G06F 11/3055

(57) ABSTRACT

An information handling system includes a first processor core that receives a first System Management Interrupt (SMI) event, and synchronizes entry into a System Management Mode (SMM) with second and third processor cores. In response to the first, second, and third processor cores being in the SMM, the first processor executes a first SMI handler to service the first SMI. While the first, second, and third processor core are in the SMM, the second processor core monitors for a high priority SMI event. In response to a detection of the high priority SMI event, the second processor core executes a second SMI handler to service the high priority SMI event.

### FIELD OF THE DISCLOSURE

The present disclosure generally relates to information handling systems, and more particularly relates to handling high priority system management interrupts.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements may vary between different applications. Thus information handling systems may also vary regarding what information is handled, how the information is handled, how much information is processed, stored, or communicated, and how quickly and efficiently the information may be processed, stored, or communicated. The variations in information handling systems allow information handling systems to be general or configured for a specific user or specific use such as financial transaction processing, airline reservations, enterprise data storage, or global communications. In addition, information handling systems may include a variety of hardware and software resources that may be configured to process, store, and communicate information and may include one or more computer systems, graphics interface systems, data storage systems, networking systems, and mobile communication systems. Information handling systems may also implement various virtualized architectures. Data and voice communications among information handling systems may be via networks that are wired, wireless, or some combination.

### SUMMARY

An information handling system may include a first processor core that receives a first system management interrupt (SMI) event, and synchronizes entry into a system management mode (SMM) with second and third processor cores. In response to the first, second, and third processor cores being in the SMM, the first processor may execute a first SMI handler to service the first SMI. While the first, second, and third processor core are in the SMM, the second processor core may monitor for a high priority SMI event. In response to a detection of the high priority SMI event, the second processor core may execute a second SMI handler to service the high priority SMI event. In response to completion of the high priority SMI, the second processor core may determine whether the first processor core is ready to exit the SMM. In response to the first processor core being ready to exit the SMM, the second processor core may synchronize an exit from the first SMI with the first and third processor cores.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a general information handling system according to at least one embodiment of the disclosure;

FIG. 2 is a block diagram of a portion of an information handling system according to at least one embodiment of the disclosure;

FIG. 3 is a flow diagram illustrating a method for handling system management interrupts within an information handling system according to at least one embodiment of the disclosure;

FIG. 4 is a flow diagram illustrating a method for handling high priority system management interrupts within an information handling system according to at least one embodiment of the disclosure; and

FIG. 5 is a flow diagram illustrating another method for handling high priority system management interrupts within an information handling system according to at least one embodiment of the disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

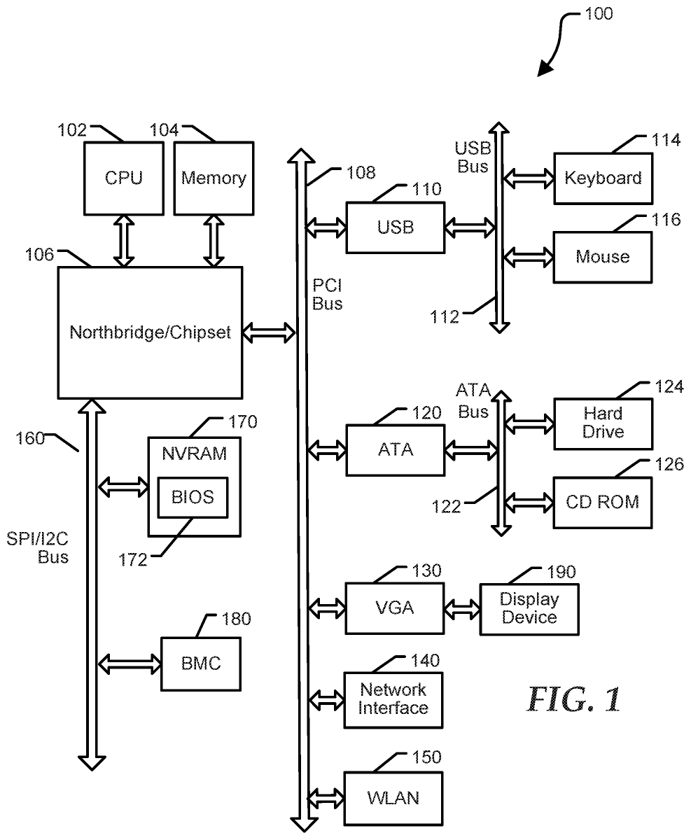

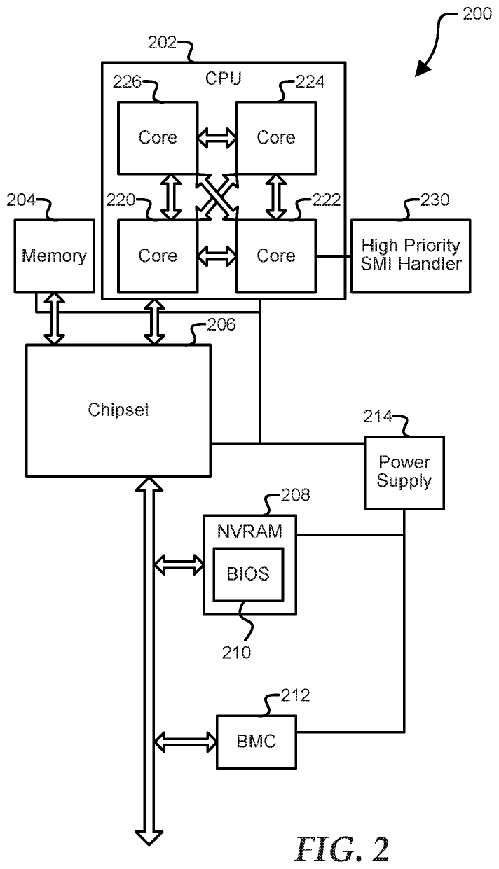

FIG. 1 illustrates a general information handling system 100 including a processor 102, a memory 104, a northbridge/chipset 106, a PCI bus 108, a universal serial bus (USB) controller 110, a USB bus 112, a keyboard device controller 114, a mouse device controller 116, a configuration an ATA bus controller 120, an ATA bus 122, a hard drive device controller 124, a compact disk read only memory (CD ROM) device controller 126, a video graphics array (VGA) device controller 130, a network interface controller (NIC) 140, a wireless local area network (WLAN) controller 150, a serial peripheral interface (SPI) bus 160, a NVRAM 170 for storing BIOS 172, and a baseboard management controller (BMC) 180. In an embodiment, information handling system 100 may be information handling system 200 of FIG. 2. BMC 180 can be referred to as a service processor or embedded controller (EC). Capabilities and functions provided by BMC 180 can vary considerably based on the type of information handling system. For example, the term baseboard management system is often used to describe an embedded processor included at a server, while an embedded controller is more likely to be found in a consumer-level device. As disclosed herein, BMC 180 represents a processing device different from CPU 102, which provides various management functions for information handling system 100. For example, an embedded controller may be responsible for power management, cooling management, and the like. An embedded controller included at a data storage system can be referred to as a storage enclosure processor.

For purpose of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as CPU 102, a programmable logic array (PLA), an embedded device such as a System-on-a-Chip (SoC), or other control logic hardware. Information handling system 100 can also include one or more computer-readable medium for storing machine-executable code, such as software or data.

System 100 can include additional processors that are configured to provide localized or specific control functions, such as a battery management controller. Bus 160 can include one or more busses, including a SPI bus, an I2C bus, a system management bus (SMBUS), a power management bus (PMBUS), and the like. BMC 180 can be configured to provide out-of-band access to devices at information handling system 100.

BIOS 172 can be referred to as a firmware image, and the term BIOS is herein used interchangeably with the term firmware image, or simply firmware. BIOS 172 includes instructions executable by CPU 102 to initialize and test the hardware components of system 100, and to load a boot loader or an operating system (OS) from a mass storage device. BIOS 172 additionally provides an abstraction layer for the hardware, such as a consistent way for application programs and operating systems to interact with the keyboard, display, and other input/output devices. When power is first applied to information handling system 100, the system begins a sequence of initialization procedures. During the initialization sequence, also referred to as a boot sequence, components of system 100 are configured and enabled for operation, and device drivers can be installed. Device drivers provide an interface through which other components of the system 100 can communicate with a corresponding device. For example, BIOS 172 may load System Management Interrupt (SMI) handlers into memory 104 to enable BMC 180 to interface with the memory.

Information handling system 100 can include additional components and additional buses, not shown for clarity. For example, system 100 can include multiple processor cores, audio devices, and the like. While a particular arrangement of bus technologies and interconnections is illustrated for the purpose of example, one of ordinary skilled in the art will appreciate that the techniques disclosed herein are applicable to other system architectures. System 100 can include multiple CPUs and redundant bus controllers. One or more components can be integrated together. For example, portions of northbridge/chipset 106 can be integrated within CPU 102. Additional components of information handling system 100 can include one or more storage devices that can store machine-executable code, one or more communications ports for communicating with external devices, and various input and output (I/O) devices, such as a keyboard, a mouse, and a video display. For example, device controller 130 may provide data to a display device 190 to visually present the information to an individual associated with information handling system 100. An example of information handling system 100 includes a multi-tenant chassis system where groups of tenants (users) share a common chassis, and each of the tenants has a unique set of resources assigned to them. The resources can include blade servers of the chassis, input/output (I/O) modules, Peripheral Component Interconnect-Express (PCIe) cards, storage controllers, and the like.

Information handling system 100 can include a set of instructions that can be executed to cause the information handling system to perform any one or more of the methods or computer based functions disclosed herein. The information handling system 100 may operate as a standalone device or may be connected to other computer systems or peripheral devices, such as by a network.

In a networked deployment, the information handling system 100 may operate in the capacity of a server or as a client user computer in a server-client user network environment, or as a peer computer system in a peer-to-peer (or distributed) network environment. The information handling system 100 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single information handling system 100 is illustrated, the term “system” shall also be taken to include any collection of systems or sub-systems that individually or jointly execute a set, or multiple sets, of instructions to perform one or more computer functions.

The information handling system 100 can include a disk drive unit and/or a solid-state storage and may include a computer-readable medium, not shown in FIG. 1, in which one or more sets of instructions, such as software, can be embedded. Further, the instructions may embody one or more of the methods or logic as described herein. In a particular embodiment, the instructions may reside completely, or at least partially, within system memory 104 or another memory included at system 100, and/or within the processor 102 during execution by the information handling system 100. The system memory 104 and the processor 102 also may include computer-readable media.

FIG. 2 illustrates a functional block diagram of a portion of an information handling system 200 according to one aspect of the disclosure. Information handling system 200 may be employed, in whole or in part, by information handling system 100 illustrated in FIG. 1, or any other system, device, component, etc. operable to employ portions, or all of, the information handling system. Information handling system 200 includes a processor 202, a memory 204, a chipset 206, a NVRAM 208 for storing a BIOS 210, a BMC 212, and a power supply 214. In an example, BMC 212 may be any suitable type of controller, such as a BMC in accordance with an IPMI specification, an Integrated Dell Remote Access Controller (iDRAC), or the like. Power supply 214 may be connected to an alternating current (AC) power source and provide power to the components of information handling system 200 via a direct current (DC) voltage rail. Information handling system 200 may include additional components (not shown in FIG. 2), without varying from the scope of this disclosure.

In an example, processor 202 may be a multi-core processor including one or more of processor cores 220, 222, 224, 226, or any combination thereof. In an example, core 220 may be operable as a bootstrap processor (BSP) to boot or initialize an information handling system. Core 220, operable as a BSP, may further process critical functions including error logging. In an embodiment, if core 220 is the BSP of processor 202, then cores 222, 224, and 226 are operable as application processors (APs) of the processor. In an example, processor 202 may be coupled to chipset 206 operable to be coupled to one or more interfaces or I/O devices.

In an example, BMC 212 may be used with, or replaced by, a trusted platform module (TPM), integrated management controller (IMC), or any combination thereof, operable to be used in association with SMI events. For example, BMC 212 may include a service processor (SP) that may monitor operating states of information handling system 200. In an example, BMC 212 may be used with core 220 of processor 202 and a local SMI event handler operable to process SMI events. BMC 212 may also be used with core 222 of processor 202 operable to use a high priority SMI event handler 230 operable to process high priority SMI events.

During operation, core 220 may detect a SMI event occurrence. The SMI event may be initiated at a resource local to processor 202 or via a resource coupled to chipset 206. In an example, one or more hardware or software components of an information handling system, such as information handling system 100 of FIG. 1, may generate the SMI.

Upon an occurrence of an SMI, processor 202 enters into a system management mode (SMM). While processor 202 is in the system management mode, all other processes running on the processor halt and BIOS 210 may control the processes running on the processor. For example, when in the system management mode, core 220 may operate as the BSP to execute the SMI handler associated with the SMI event, and cores 222, 224, and 226 may halt their processes and enter a loop waiting for core 220, operating as the BSP, to complete the SMI.

In an example, the SMI, being executed by core 220, may be any suitable type of SMI including, but not limited to, a time consuming SMI. In an example, a time consuming SMI may be any SMI that may take the core a while to complete the execution/servicing of the SMI. A time consuming SMI may be any suitable SMI including, but not limited to, a serial presence detect (SPD) error logging SMI. Other examples of SMIs may fall into three categories: software SMIs, hardware SMIs due to correctable errors, and hardware SMIs due to uncorrectable errors. In an example, software SMIs may include utilization of BIOS application programming interfaces (APIs), such as changing a BIOS setting, or setting the system event log (SEL) time. An example of a correctable error is a single-bit error when reading memory contents from a dual inline memory module (DIMM). In an example, uncorrectable errors may include multi-bit errors from a DIMM, or a fatal PCI error, or a PCI completion timeout. In each case, if in SMI mode, the handling of another SMI request would necessarily have to wait under previous architectures.

During the execution of the SMI, another SMI may be provided to processor 202 and this SMI may be a high priority SMI that needs to be serviced immediately. However, in some situations, core 220 may not complete the SMI until it is too late, such that the event that generated the high priority SMI is already completed. In an example, a high priority SMI may be any suitable type of SMI including, but not limited to, a SMI indicating an alternating current (AC) loss condition within information handling system 200, in which case a SMI handler may need to immediately flush the memory controller to a non-volatile memory device in order to avoid loss of data. In an example, other high priority SMIs may include, but are not limited to, an uncorrectable error from a memory or PCIe device may require immediate treatment or logging, such that the SMI may need to preempt a software SMI.

In certain examples, memory 204 may be a persistent memory that includes a battery backup to power the memory, during an AC loss condition, so that data stored within the memory can be copied from a volatile region to a non-volatile region before it is lost. The AC loss condition may invoke a high priority SMI because if information handling system 200 does not immediately flush memory controller contents or cache, some writes to memory may be incomplete, and the battery power for memory 204 may be exhausted by the other components within the information handling system, such that insufficient battery power is left for the memory to complete its “save” operation. Thus, information handling system 200 may be improved by implementing a high priority SMI handler 230 to enable core 222 to service a high priority SMI event while core 220 is currently executing another SMI. In an example, the high priority SMI handler 230 may enable the high priority SMI to be timely executed, and thereby prevent issues within information handling system 200.

In an example, while core 220 is servicing a SMI, cores 224 and 226 may be in a loop waiting for core 220 to complete the SMI. However, during this process, core 222 may receive and execute different code, as compared to cores 224 and 226, from BIOS 210, and this code may cause core 222 to monitor one or more components within information handling system 200 for SMI events. In an example, core 222 may monitor for any suitable SMI events including, but not limited to, high priority SMI events. As stated above, a high priority SMI event may be an AC loss condition within power supply 214. In this example, any suitable component including, but not limited to, BMC 212 and a complex processor logic device (CPLD) may indicate whether the AC loss condition has occurred. For example, BMC 212 may monitor power supply 214, and may detect whether an AC loss condition has occurred. In response to the detection of the AC loss condition, BMC 212 may provide the high priority SMI to core 222, which in turn may begin execution of high priority SMI handler 230. With respect to the CPLD, core 222 may monitor a corresponding CPLD bit to determine whether an AC loss condition has been detected.

In response to a determination that the high priority SMI event has not occurred, core 222 may check a semaphore for core 220 to determine a current state of core 220. In this example, the semaphore for core 220 may be a variable within the code of the core to indicate whether the SMI should be exited. In response to the semaphore for core 220 indicating that the SMM should be exited, core 222 along with cores 224 and 226 may synchronize their exit from the SMM with that of core 220.

In response to reception of the high priority SMI, via the CPLD bit being set or a signal from BMC 212, core 222 may immediately call high priority SMI handler 230. In an example, high priority SMI handler 230 may be called regardless of a current state of the SMI code being executed by core 220. In this situation, core 222 may serve the high priority SMI while core 220 is currently executing another SMI, such that the high priority SMI is serviced in a timely manner. In response to the handling of the high priority SMI being completed, core 222 may check the semaphore of core 220. Based on the semaphore of core 220, core 222 may perform one or more operations, as described above, to synchronize its exit from the SMM with core 220.

In an additional or alternative example, after completion of a high priority SMI, core 222 may detect another high priority SMI before the semaphore of core 220 indicating that the SMI being executed by the core 220 is ready to be exited. In this example, core 222 may perform one or more operations, as described above, to handle the high priority SMI via high priority SMI handler 230.

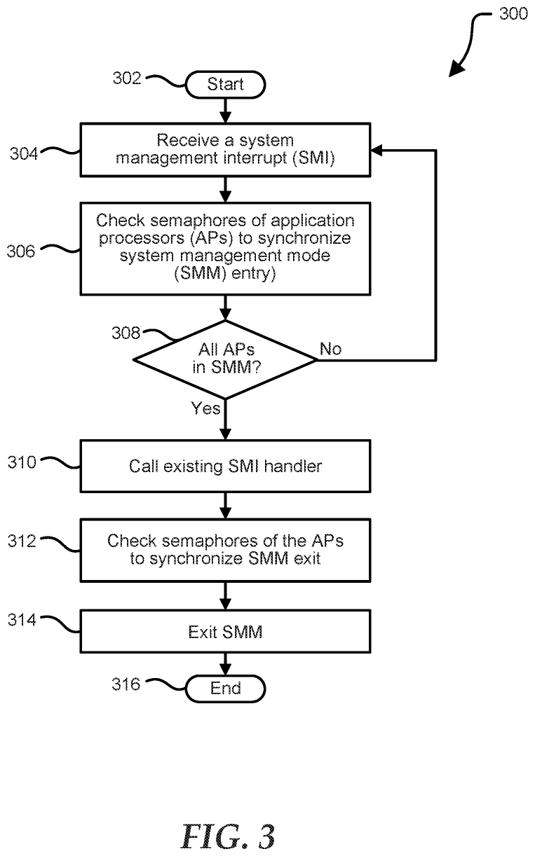

FIG. 3 is a flow diagram illustrating a method 300 for handling system management interrupts within an information handling system, starting at block 302. It will be readily appreciated that not every method step set forth in this flow diagram is always necessary, and that certain steps of the methods may be combined, performed simultaneously, in a different order, or perhaps omitted, without varying from the scope of the disclosure. FIG. 3 may be employed in whole, or in part, by information handling system 100 depicted in FIG. 1, information handling system 200 described in FIG. 2, or any other type of system, controller, device, module, processor, or any combination thereof, operable to employ all, or portions of, the method of FIG. 3.

At block 304, a system management interrupt (SMI) is received. In an example, a SMI may be received by a bootstrap processor (BSP) core of a multi-core processor. In certain examples, the SMI may be received from any suitable source including, but not limited to, a network controller, an input device, a display device, a memory device, a storage device, and a power source device. At block 306, semaphores of application processors (APs) are checked to synchronize system management mode (SMM) entry. In an example, the BSP may perform one or more operations to check the semaphores of the APs to determine whether the APs are in a state that enable the APs to enter the SMM. In an embodiment, a semaphore for an AP is a variable to indicate whether the AP is in a particular condition to enable the AP to enter the SMM or to indicate that the AP is in the SMM.

At block 308, a determination is made whether all APs are in the SMM. If not all of the APs are in the SMM, the flow continues as described above at block 304. If all of the APs are in the SMM, an existing SMI handler is called at block 310. In example, the SMI handler may be executed by the BSP and the APs may wait in a loop for the BSP to finish the SMM. In certain examples, different SMIs may take different amounts of time to be executed. For example, a serial presence detect (SPD) error logging SMI may be a time consuming SMI.

At block 312, semaphores of the APs are checked to synchronize an exit from the SMM. In an example, the BSP may perform one or more operations to check the semaphores of the APs to determine whether the APs are in a state that enable the APs to exit the SMM. In an embodiment, the semaphore check is performed to determine whether one of the APs is performing another SMI, such as a high priority SMI as discussed herein. At block 314, the SMM is exited, and the method ends in block 316.

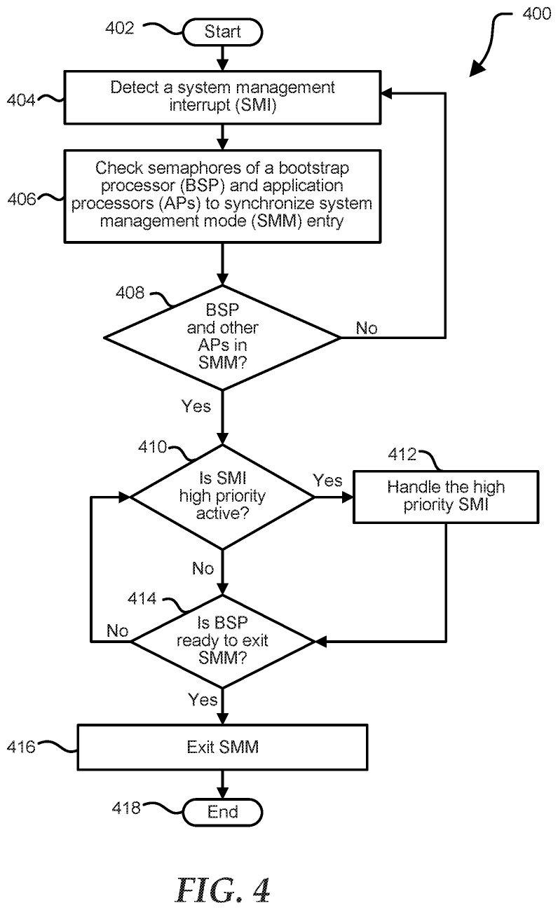

FIG. 4 is a flow diagram illustrating a method 400 for handling high priority system management interrupts within an information handling system, starting at block 402. It will be readily appreciated that not every method step set forth in this flow diagram is always necessary, and that certain steps of the methods may be combined, performed simultaneously, in a different order, or perhaps omitted, without varying from the scope of the disclosure. FIG. 4 may be employed in whole, or in part, by information handling system 100 depicted in FIG. 1, information handling system 200 described in FIG. 2, or any other type of system, controller, device, module, processor, or any combination thereof, operable to employ all, or portions of, the method of FIG. 4.

At block 404, a system management interrupt (SMI) is detected. In an example, a bootstrap processor (BSP) may detect the SMI. At block 406, semaphores of the BSP and the application processor (APs) are checked to synchronize system management mode (SMM) entry. In an example, the semaphores of the BSP and the other APs may indicate whether the BSP and the APs are in states that enable the BSP and APs to enter into the SMM.

At block 408, a determination is made whether the BSP and the other APs are in a SMM. If the BSP and the other APs are not in a SMM, the flow continues as described above at block 404. If the BSP and the other APs are in a SMM, a determination is made whether a high priority SMI is active at block 410. In an example, the high priority SMM may be detected by an AP while the BSP is currently executing a SMI. In certain examples, the high priority SMI may be any suitable SMI that needs to be performed before another SMI is completed including, but not limited to, a time sensitive SMI, such as an alternating current (AC) loss condition.

If the high priority SMI is active, the SMI is handled at block 412 and the flow continues at block 414. However, if the high priority SMI is not active, a determination is made whether the BSP is ready to exit the SMM at block 414. If the BSP is not ready to exit the SMM, the flow continues as stated above at block 410. If the BSP is ready to exit the SMM, the SMM is exited at block 416 and the method ends in block 418.

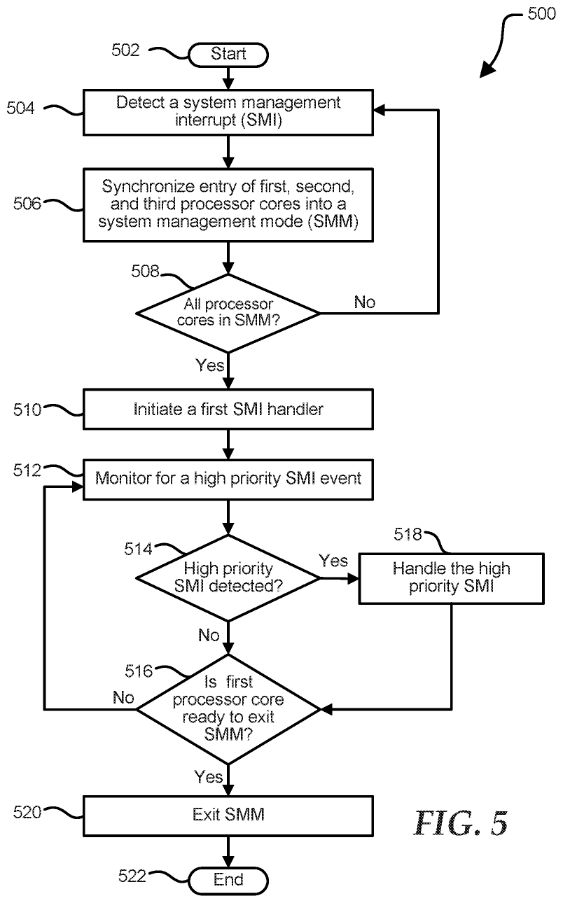

FIG. 5 is a flow diagram illustrating a method 500 for handling high priority system management interrupts within an information handling system, starting at block 502. It will be readily appreciated that not every method step set forth in this flow diagram is always necessary, and that certain steps of the methods may be combined, performed simultaneously, in a different order, or perhaps omitted, without varying from the scope of the disclosure. FIG. 5 may be employed in whole, or in part, by information handling system 100 depicted in FIG. 1, information handling system 200 described in FIG. 2, or any other type of system, controller, device, module, processor, or any combination thereof, operable to employ all, or portions of, the method of FIG. 5.

At block 504, a system management interrupt (SMI) is detected. In an example, a bootstrap processor (BSP) of an information handling system may detect the SMI. At block 506, entry into a system management mode (SMM) for first, second, and third processor cores within the information handling system. In an example, the first processor core may be the BSP of the information handling system, and the second and third processor cores may be application processors (APs).

At block 508, a determination is made whether all of the first, second, and third processor cores are in the first SMI. If not all of the first, second, and third processor cores are in the SMM, the flow continues as state above at block 504. If all of the first, second, and third processor cores are in the SMM, a first SMI handler is initiated at block 510. In an example, the first processor operating as the BSP may execute the first SMI handler to service the first SMI event.

At block 512, a high priority SMI event is monitored. In an example, the second processor core, operating as an AP, may monitor for the high priority SMI event. In certain examples, the high priority SMI event may be a time sensitive SMI, such as an AC loss condition. At block 514, a determination is made whether the high priority SMI has been detected.

In response to the high priority SMI event not being detected, the flow continues at block 516. In response to the detection of the high priority SMI event, the high priority SMI event is handled at block 518. In an example, the second processor core may handle the high priority SMI event by executing a second SMI handler to service the high priority SMI event. At block 516, a determination is made whether the first processor core is ready to exit the SMI. If the first processor core is not ready to exit the SMM, the flow continues as stated above at block 512. If the first processor core is ready to exit the SMM, the first, second and third processor cores synchronize an exit from the SMI at block 520 and the method ends at block 522.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to store information received via carrier wave signals such as a signal communicated over a transmission medium. Furthermore, a computer readable medium may store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

When referred to as a “device,” a “module,” or the like, the embodiments described herein may be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The device or module may include software, including firmware embedded at a processor or software capable of operating a relevant environment of the information handling system. The device or module may also include a combination of the foregoing examples of hardware or software. Note that an information handling system may include an integrated circuit or a board-level product having portions thereof that may also be any combination of hardware and software.

Devices, modules, resources, or programs that are in communication with one another need not be in continuous communication with each other, unless expressly specified otherwise. In addition, devices, modules, resources, or programs that are in communication with one another may communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

1. (canceled)

2. (canceled)

3. (canceled)

4. (canceled)

5. (canceled)

6. (canceled)

7. (canceled)

8. An information handling system, comprising:
a first processor core of a multi-core processor to receive a first System Management Interrupt (SMI) event, to synchronize entry into a System Management Mode (SMM) with second and third processor cores of the multi-core processor, in response to the first, second, and third processor cores being in the SMM, the first processor core to execute a first SMI handler to service the first SMI; and
the second processor core coupled to the first processor core, while the first processor core is executing the first SMI handler to service the first SMI, the second processor core to:
monitor for a high priority SMI event; and
in response to a detection of the high priority SMI event, execute a second SMI handler to service the high priority SMI event.

9. The information handling system of claim 8, while the first, second, and third processor core are in the SMM, the second processor core further to:
in response to completion of the high priority SMI event, determine whether the first processor core is ready to exit the SMM; and
in response to the first processor core being ready to exit the SMM, synchronize an exit from the SMM with the first and third processor cores.

10. The information handling system of claim 9, wherein the determination of whether the first processor core is ready to exit the SMM, the second processor core to check a semaphore of the first processor.

11. The information handling system of claim 8, further comprising:
a basic input/output system (BIOS) to communicate with the first, second, and third processor cores, in response to the first SMI event, the BIOS to provide first code to the first processor and second code to the second processor code, wherein the first code causes the first processor core to execute the first SMI handler, and the second code causes the second processor core to monitor for the high priority SMI event.

12. The information handling system of claim 8, wherein the third processor core to execute a loop to wait for the first processor core to compete the first SMI, and to synchronize the exit from the SMM with the first processor.

13. The information handling system of claim 8, wherein in response to the high priority SMI event not being detected, the second processor core to determine whether the first processor core is ready to exit the SMM; and in response to the first processor core being ready to exit the SMM, the second processor core to synchronize an exit from the SMM with the first and third processor cores.

14. The information handling system of claim 8, the second processor further to detect the high priority SMI via a signal on a dedicated pin of the multi-core processor.

15. A method, comprising:
receiving, by a first processor core of a multi-core processor of an information handling system, a first System Management Interrupt (SMI) event;
synchronizing entry into a System Management Mode (SMM) with second and third processor cores of the multi-core processor in response to receiving the first SMI event; and
in response to the first, second, and third processor cores being in the SMM, executing, by the first processor core, to a first SMI handler to service the first SMI;
wherein the first processor core is executing the first SMI handler to service the first SMI, the method further comprises:
monitoring, by the second processor core, for a high priority SMI event; and
in response to a detection of the high priority SMI event, executing, by the second processor core, a second SMI handler to service the high priority SMI event.

16. The method of claim 15, while the first, second, and third processor core are in the SMM, the method further comprises:
in response to completion of the high priority SMI event, determining, by the second processor core, whether the first processor core is ready to exit the SMM; and
in response to the first processor core being ready to exit the SMM, synchronizing, by the second processor core, an exit from the SMM with the first and third processor cores.

17. The method of claim 16, wherein the determining of whether the first processor core is ready to exit the SMM, further comprises:
checking, by the second processor core, a semaphore of the first processor.

18. The method of claim 15, the method further comprising:
in response to the first SMI event:
providing, by a basic input/output system (BIOS) of the information handling system, first code to the first processor, wherein the first code causes the first processor core to execute the first SMI handler; and
providing, by the BIOS, second code to the second processor code, wherein the second code causes the second processor core to monitor for the high priority SMI event.

19. The method of claim 15, further comprising:
executing, by the third processor core, a loop to wait for the first processor core to compete the first SMI; and
synchronizing, by the third processor core, the exit from the SMM with the first processor.

20. The method of claim 15, further comprising:
in response to the high priority SMI event not being detected, determining, by the second processor core, whether the first processor core is ready to exit the SMM; and
in response to the first processor core being ready to exit the SMM, synchronizing, by the second processor core, an exit from the SMM with the first and third processor cores.

21. An information handling system, comprising:
a first processor core of a multi-core processor to receive a first System Management Interrupt (SMI) event, to synchronize entry into a System Management Mode (SMM) with a second processor core of the multi-core processor, and in response to the first and second processor cores being in the SMM, the first processor core to execute a first SMI handler out of a basic input/output system (BIOS) of the information handling system to service the first SMI; and
the second processor core of the multi-core processor coupled to the first processor core, while the first processor core is executing the first SMI handler out of a memory device of the information handling system to service the first SMI, the second processor core to:
receive a high priority SMI event; and
in response to receiving the high priority SMI event, execute a second SMI handler to service the high priority SMI event.

22. The information handling system of claim 21, while the first and second processor cores are in the SMM, the second processor core further to:
in response to completion of the high priority SMI event, determine whether the first processor core is ready to exit the SMM; and
in response to the first processor core being ready to exit the SMM, synchronize an exit from the SMM with the first processor cores.

23. The information handling system of claim 22, wherein the determination of whether the first processor core is ready to exit the SMM, the second processor core to check a semaphore of the first processor.

24. The information handling system of claim 21, wherein the BIOS communicates with the first and second processor cores, in response to the first SMI event to provide first code to the first processor and second code to the second processor code, wherein the first code causes the first processor core to execute the first SMI handler, and the second code causes the second processor core to monitor for the high priority SMI event.

25. The information handling system of claim 21, wherein a third processor core executes a loop to wait for the first processor core to compete the first SMI, and to synchronize the exit from the SMM with the first processor.

26. The information handling system of claim 21, wherein in response to the high priority SMI event not being detected, the second processor core to determine whether the first processor core is ready to exit the SMM; and in response to the first processor core being ready to exit the SMM, the second processor core to synchronize an exit from the SMM with the first processor core.

27. The information handling system of claim 21, the second processor further to detect the high priority SMI via a signal on a dedicated pin of the multi-core processor.
